(19) United States
(12) Patent Application Publication
(10) Pub. No.: US 2014/0376731 A1
(43) Pub. Date: Dec. 25, 2014

(54) Noise Suppression Method and Audio Processing Device

(71) Applicant: KABUSHIKI KAISHA TOSHIBA, Tokyo (JP)

(72) Inventor: Takehiko Isaka, Hachioji-shi (JP)

(73) Assignee: KABUSHIKI KAISHA TOSHIBA, Tokyo (JP)

(21) Appl. No.: 14/179,395

(22) Filed: Feb. 12, 2014

(30) Foreign Application Priority Data
Jun. 24, 2013 (JP) 2013-131478

(51) Int. Cl. H04R 3/00

(52) U.S. Cl. CPC H04R 3/002
USPC 381/71.1

(57) ABSTRACT

One embodiment provides an audio processing device including: a first audio input receiver configured to receive mainly environment noise; a second audio input receiver configured to receive mainly a voice; a first frequency band difference calculator configured to calculate a first power difference, obtained through accumulation over plural frequency bands, of signals output from the first audio input receiver and the second audio input receiver; a first noise suppression amount calculator configured to calculate a first noise suppression amount based on the first power difference so as to increase the first noise suppression amount if the first power difference is relatively small; and a noise suppressor configured to perform a noise suppression for the signal that is output from the second audio input receiver based on the first noise suppression amount.

### CROSS-REFERENCE TO RELATED APPLICATION(S)

This application claims priority (priorities) from Japanese Patent Application No. 2013-131478 filed on Jun. 24, 2013, the entire contents of which are incorporated herein by reference.

### FIELD

Embodiments described herein relate generally to a noise suppressing method and an audio processing device.

### BACKGROUND

In audio processing devices etc., there are various demands relating to noise suppression methods. For example, in audio recording and VoIP (voice over Internet protocol) technology, there is a demand for increased ease of hearing of a sound that is input through a microphone. Correct speech recognition even in a noisy environment such as an outdoor environment is also demanded.

For example, a noise suppression method using two microphones is known in which the noise estimation speed is controlled based on differences between powers in respective frequency bands of signals generated by the two microphones. This prior art technique has an advantage that noise estimation can be performed with high accuracy both in a non-voice interval and a voice interval. However, since only the frequency band of a subject of suppression is considered, this technique tends to cause a problem that, for example, suppression is made in a partial, low-power noise frequency range or suppression is not made in a partial, high-power noise range. This results in side effects such as attenuation of a human voice or noise not being suppressed properly.

Whereas there are demands for techniques capable of suppressing noise properly, no means for satisfying those demands are available.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a schematic front view showing an appearance of an electronic apparatus according to an embodiment.

FIG. 2 is a block diagram showing an example hardware configuration of the electronic apparatus according to the embodiment.

FIG. 3 is a block diagram showing a detailed configuration of an audio processor used in the embodiment.

FIG. 4 is a rough block diagram showing the configuration of part of the audio processor and other components.

FIG. 5 is a flowchart of a noise suppression process according to the embodiment.

### DETAILED DESCRIPTION

One embodiment provides an audio processing device including: a first audio input receiver configured to receive mainly environment noise; a second audio input receiver configured to receive mainly a voice; a first frequency band difference calculator configured to calculate a first power difference, obtained through accumulation over plural frequency bands, of signals output from the first audio input receiver and the second audio input receiver; a first noise suppression amount calculator configured to calculate a first noise suppression amount based on the first power difference so as to increase the first noise suppression amount if the first power difference is relatively small; and a noise suppressor configured to perform a noise suppression for the signal that is output from the second audio input receiver based on the first noise suppression amount.

An electronic apparatus and its control method will be hereinafter described in detail as an embodiment of an audio processing device with reference to the accompanying drawings. The following embodiment will be directed to an electronic apparatus that is used being gripped by a user, such as a cellphone, a smartphone, a (slate) tablet terminal, a PDA, an electronic book reader, a digital photo frame, or the like.

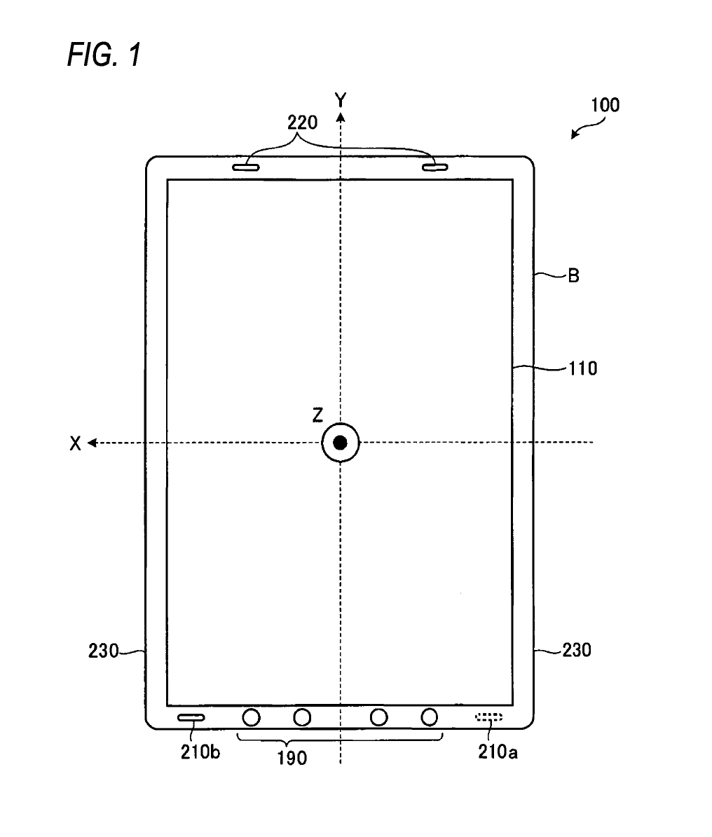

FIG. 1 is a schematic front view showing an appearance of an electronic apparatus 100 according to the embodiment which is an information processing apparatus having a display screen. Coordinate axes are shown in FIG. 1 (the positive direction of the Z axis is directed to the front side) and will be used in the following description.

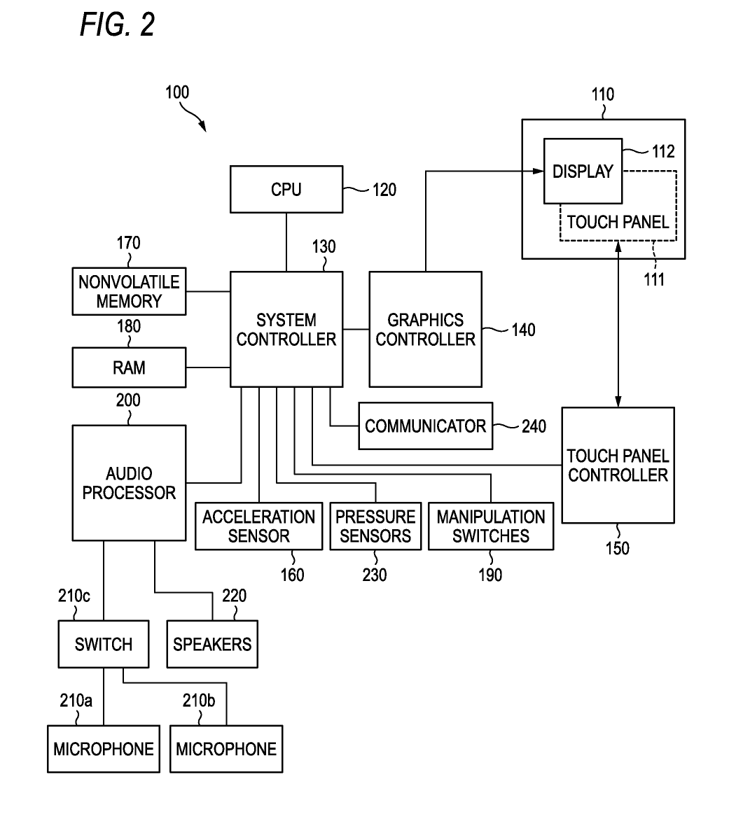

The electronic apparatus 100 has a thin, box-shaped body B and the screen of a display device 110 is generally flush with the front surface of the body B. The display device 110 is equipped with a touch panel 111 (see FIG. 2) for detecting a user touch position on the display screen. The bottom portion of the front surface of the body B is provided with manipulation switches 190 which allow a user to perform various manipulations and microphones 210a and 210b for picking up a user voice. The microphones 210a and 210b are provided on the back surface and the front surface of the body B, respectively. The microphone 210a is mainly for the purpose of picking up ambient noise, and the microphone 210b is mainly for the purpose of picking up a voice. It is preferable that each of the microphones 210a and 210b have a certain degree of directivity.

The top portion of the front surface of the body B is provided with speakers 220 for sound output.

The left and right (in the X-axis direction) side surfaces of the body B are provided with pressure sensors 230 for detecting pressure that is exerted by the user who is gripping the body B. Alternatively, the top and bottom (in the Y-axis direction) side surfaces of the body B may be provided with pressure sensors 230.

FIG. 2 is a block diagram showing an example hardware configuration of the electronic apparatus 100 according to the embodiment. As shown in FIG. 2, the electronic apparatus 100 is equipped with, in addition to the above-described components, a CPU 120, a system controller 130, a graphics controller 140, a touch panel controller 150, an acceleration sensor 160, a nonvolatile memory 170, a RAM 180, an audio processor 200, a communicator 240, etc. The built-in or external microphones 210a and 210b are connected to the audio processor 200 via an analog switch 210c. The microphones 220 are also connected to the audio processor 200.

The display device 110 is composed of a touch panel 111 and a display 112 such as an LCD (liquid crystal display) or an organic EL (electroluminescence) display. For example, the touch panel 111 is a coordinates detecting device which is disposed on the display screen of the display 112 and serves to detect coordinates on this surface. The touch panel 111 can detect a position (touch position) on the display screen where it has been touched by, for example, a finger of the user who is gripping the body B. This function of the touch panel 111 allows the display 112 to serve as what is called a touch screen.

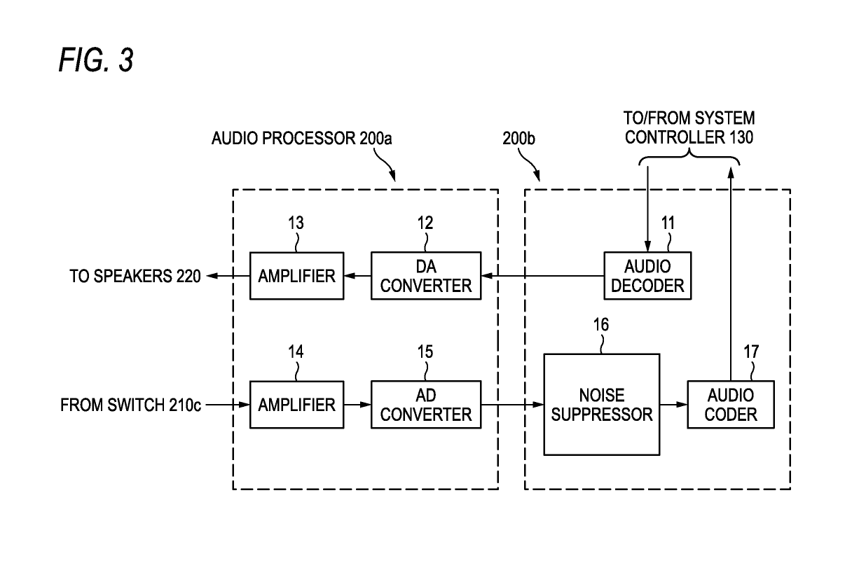

The CPU 120 is a central processor for controlling the operations of the electronic apparatus 100, and controls the individual components of the electronic apparatus 100 via the system controller 130. The CPU 120 realizes individual functional components (described below with reference to FIG. 3 etc.) by running an operating system and various application programs that are loaded into the RAM 180 from the nonvolatile memory 170. As a main memory of the electronic apparatus 100, the RAM 180 provides a work area to be used by the CPU 120 when it runs programs.

The system controller 130 incorporates a memory controller for access-controlling the nonvolatile memory 170 and the RAM 180. The system controller 130 has a function of communicating with the graphics controller 140. The system controller 130 also has a function of sending an audio signal indicating, for example, an audio waveform to an external server (not shown) via the communicator 240, the Internet, etc. and, if necessary, receiving a result of speech recognition performed on the audio waveform.

The graphics controller 140 is a display controller for controlling the display 112 which is used as a display monitor of the electronic apparatus 100. The touch panel controller 150 controls the touch panel 111 and thereby acquires, from the touch panel 111, coordinate data that indicates a user touch position on the display screen of the display 112.

For example, the acceleration sensor 160 is a 6-axis acceleration sensor capable of detection of acceleration in the three axis directions shown in FIG. 1 (i.e., X, Y, and Z directions) and acceleration in the rotation directions around the respective axis directions. The acceleration sensor 160 detects the direction and the magnitude of acceleration of the electronic apparatus 100 that is caused externally and outputs detection results to the CPU 120. More specifically, the acceleration sensor 160 outputs, to the CPU 120, an acceleration detection signal (inclination information) including information of acceleration-detected axes, a direction (in the case of rotation, a rotation angle), and a magnitude. A gyro sensor for detection of an angular velocity (rotation angle) may be integrated with the acceleration sensor 160.

The audio processor 200 performs audio processing such as digital conversion, noise elimination, and echo cancellation on audio signals supplied from the microphones 210a and 210b via the switch 210c, and outputs a resulting signal to the CPU 120 via the system controller 130. Furthermore, the audio processor 200 performs audio processing such as voice synthesis under the control of the CPU 120, and supplies a generated audio signal to the speakers 220 to make a voice notification through the speakers 220. The audio processor 200 is equipped with a noise suppressor 16 (described later). The audio processor 200 will be described below in detail.

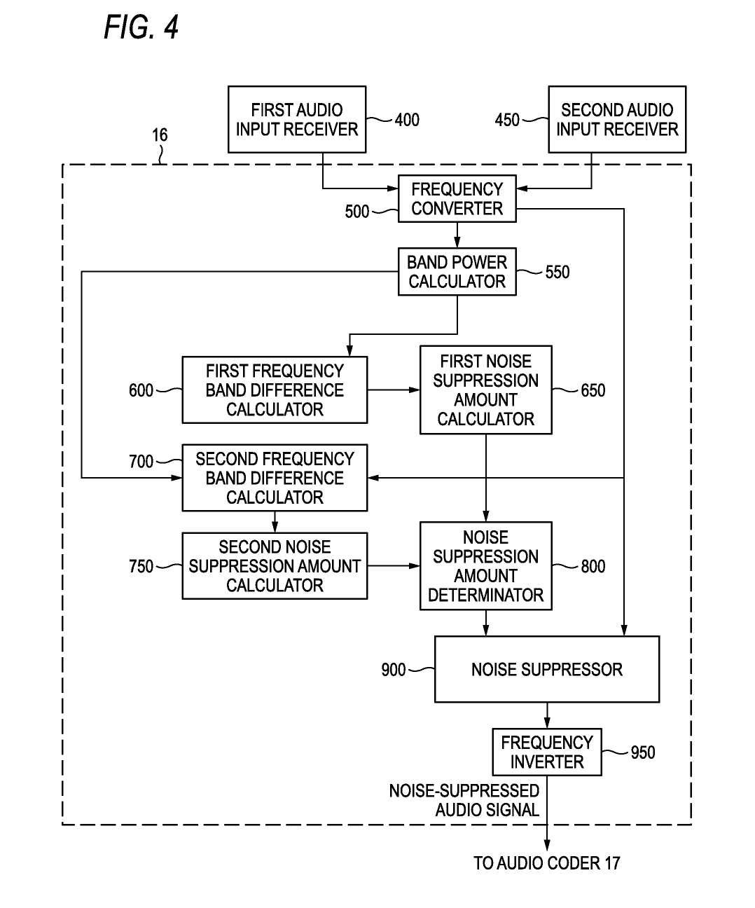

FIG. 3 is a block diagram showing a detailed configuration of the audio processor 200 used in the embodiment. The audio processor 200 has basic hardware components and software modules for various kinds of audio signal processing/computation to be performed by individual functional blocks shown in FIG. 4; that is, the audio processor 200 is composed of an audio decoder 11, a DA converter 12, amplifiers 13 and 14, an AD converter 15, the noise suppressor 16, an audio coder 17, etc.

An audio processor 200a is what is called a DA/AD converter (hardware component) which is composed of the DA converter 12, the amplifiers 13 and 14, the AD converter 15. An audio processor 200b is what is called an audio coder/decoder (software component) which is composed of the audio decoder 11, the noise suppressor 16, the audio coder 17, etc.

The audio decoder 11 performs decoding processing on a compressed audio signal supplied from the system controller 130. The DA converter 12 DA-converts a resulting audio signal. The amplifier 13 amplifies a resulting analog audio signal and outputs the amplified audio signal to the speakers 220.

The amplifier 14 amplifies audio signals supplied from the microphones 210a and 210b. The AD converter 15 AD-converts the amplified audio signals. The noise suppressor 16 performs noise suppression processing on resulting digital audio signals. The audio coder 17 performs audio compression processing on noise-suppressed audio signals and sends resulting audio signals to the system controller 130. Among the above components, the noise suppressor 16 will be described below in detail.

FIG. 4 is a rough block diagram showing the configuration of part (the noise suppressor 16 (enclosed by a broken line)) of the audio processor 200 and other components.

Among the blocks shown in FIG. 4, a first audio input receiver 400 and a second audio input receiver 450 mainly correspond to the respective microphones 210a and 210b and include parts of the audio processor 200. The other blocks (functional blocks), that is, a frequency converter 500, a band power calculator 550, a first frequency band difference calculator 600, a first noise suppression amount calculator 650, a second frequency band difference calculator 700, a second noise suppression amount calculator 750, a noise suppression amount determinator 800, a noise suppressor 900, and a frequency inverter 950, belong to the audio processor 200 (noise suppressor 16).

The first audio input receiver 400 mainly picks up environment noise, and the second audio input receiver 450 mainly picks up a voice.

More specifically, if the audio processor 200 has switched the switch 210c so that it passes an input from the microphone 210a, an audio signal generated by the microphone 210a reaches the AD converter 15 via the amplifier 14. If the audio processor 200 has switched the switch 210c so that it passes an input from the microphone 210b, an audio signal generated by the microphone 210b reaches the AD converter 15 via the amplifier 14.

Outputs of the first audio input receiver 400 and the second audio input receiver 450 are processed by the AD converter 15 and guided to the frequency converter 500 in a time-divisional manner. The first frequency band difference calculator 600 calculates differences between powers, corresponding to respective frequency bands and each obtained through accumulation over plural frequency bands, of signals that are supplied from the first audio input receiver 400 and the second audio input receiver 450 via the frequency converter 500 and the band power calculator 550. The first noise suppression amount calculator 650 calculates first noise suppression amounts in respective frequency bands based on an output of the first frequency band difference calculator 600.

The second frequency band difference calculator 700 calculates differences between powers, corresponding to respective frequency bands and each obtained through accumulation over plural frequency bands, of the signals that are supplied from the first audio input receiver 400 and the second audio input receiver 450 via the frequency converter 500 and the band power calculator 550. The calculation method may be either the same as or different (e.g., the width of the frequency bands is changed or divided into unequal intervals) from that of the first frequency band difference calculator 600. The second noise suppression amount calculator 750 calculates second noise suppression amounts in respective frequency bands based on an output of the second frequency band difference calculator 700.

The noise suppression amount determinator 800 calculates final noise suppression amounts based on the first noise suppression amounts supplied from the first noise suppression amount calculator 650 and the second noise suppression amounts supplied from the second noise suppression amount calculator 750. The noise suppressor 900 suppresses noise components contained in the audio signal that is input from the second audio input receiver 450 according to the noise suppression amounts supplied from the noise suppression amount determinator 800. The noise suppressor 900 outputs a suppression result signal to the frequency inverter 950. The audio coder 17 receives an output of the frequency inverter 950.

The noise suppression amount determinator 800 outputs, as they are, the first noise suppression amounts supplied from the first noise suppression amount calculator 650 in a voice interval and adds, with weighting if necessary, the second noise suppression amounts supplied from the second noise suppression amount calculator 750 to the first noise suppression amounts supplied from the first noise suppression amount calculator 650 in a non-voice interval, according to a detection result of a voice detector (not shown). For example, the technique disclosed in JP-4837123-B of the same applicant may be utilized to implement the voice detector.

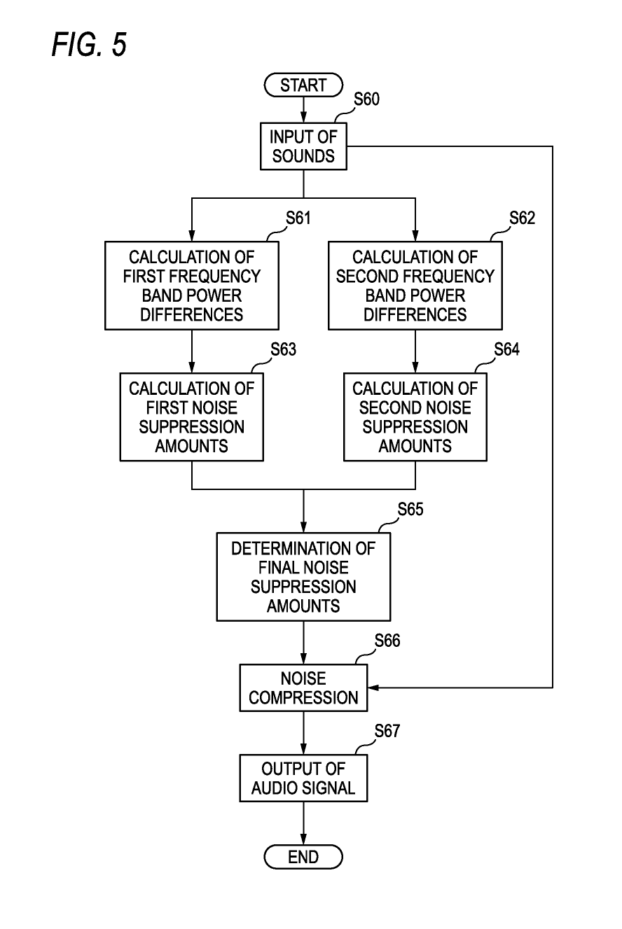

FIG. 5 is a flowchart of a noise suppression process according to the embodiment.

Step S60: Sounds are input. The first audio input receiver 400 mainly picks up environment noise with the microphone 210a. A signal representing the picked-up environment noise is amplified by the amplifier 14 and AD-converted by the AD converter 15 into a digital signal x1(t). The second audio input receiver 450 mainly picks up a voice with the microphone 210b. A signal representing the picked-up voice is amplified by the amplifier 14 and AD-converted by the AD converter 15 into a digital signal x2(t). In the audio processor 200, the switch 210c is switched to cause the first audio input receiver 400 and the second audio input receiver 450 alternately.

Step S61: First frequency band power differences are calculated in the noise suppressor 16. The first frequency band difference calculator 600 calculates differences between powers in respective frequency bands of the signals supplied from the first audio input receiver 400 and the second audio input receiver 450.

First, the frequency converter 500 performs time-to-frequency conversion on the digital signals x1(t) and x2(t) and thereby produces amplitude spectra X1(n) and X2(n), respectively. The band power calculator 550 then calculates band powers Xd1(k) and Xd2(k).

The band power calculator 550 divides each amplitude spectrum Xi(n) (i=1, 2) into spectra in, for example, 16 frequency bands, and calculates representative band powers Xdi(k) (i=1, 2; k=0 to K−1) through averaging over the respective frequency bands. The parameter K is the number of frequency bands (e.g., 16). And it is assumed that a larger k value indicates a higher frequency band. Although in this example, the divisional frequency bands have the same interval, division intervals that are more suitable for the human auditory characteristics may be employed by setting the division interval narrower as the band has lower frequencies as in the Bark scale or the mel scale. In this example, to obtain more stable power values than in the case of using powers directly calculated from each amplitude spectrum which has large instantaneous variations, each amplitude spectrum is divided into spectra in frequency bands. Alternatively, finer processing may be performed by using powers directly calculated from an amplitude spectrum in a particular frequency range (e.g., a low-frequency range) or the entire frequency range. In this manner, band powers Xdi(k) (i=1, 2) each representing powers in each frequency band are obtained.

For example, the inter-microphone level difference (ILD) at a certain time t is given by the following Equation (1) using the inter-microphone power differences of the respective frequency bands:

$$\begin{matrix}[ Formula 1 ] & \\ ILD = {\sum }_{k = 0}^{K - 1} \{ Xd 2 ( k ) - Xd 1 ( k ) \} & ( 1 )\end{matrix}$$

Where the subject frequency range is restricted, the inter-microphone level difference (ILD) is given by the following Equation (2):

$$\begin{matrix}[ Formula 2 ] & \\ ILD ( k ) = {\sum }_{i = k - N}^{K + N} \{ Xd 2 ( i ) - Xd 1 ( i ) \} & ( 2 )\end{matrix}$$

Where the absolute values of the inter-microphone power differences are used, the inter-microphone level difference (ILD) is given by the following Equation (3):

$$\begin{matrix}[ Formula 3 ] & \\ ILD = {\sum }_{k = 0}^{K - 1} \vert Xd 2 ( k ) - Xd 1 ( k ) \vert & ( 3 )\end{matrix}$$

Restricting the subject frequency range, the following Equation (4) is obtained:

$$\begin{matrix}[ Formula 4 ] & \\ ILD ( k ) = {\sum }_{i = k - N}^{K + N} \vert Xd 2 ( i ) - Xd 1 ( i ) \vert & ( 4 )\end{matrix}$$

Since the inter-microphone power differences are accumulated in the frequency band direction, filter smoothing is done in the frequency direction. Therefore, in particular, it is highly probable that large noise suppression amounts can be obtained in a non-voice interval whereas musical noise due to suppression in a voice frequency range in a voice interval is made small.

That is, some conventional methods are associated with the following problem. A signal is attenuated steeply at a frequency at which the levels of an input signal and estimated noise are approximately the same. This causes a phenomenon that a signal appears and disappears at a particular frequency because an error in the noise estimation level; tonal noise called musical noise is generated.

In Equations (1) and (2), the first noise suppression amounts may be decreased if, for example, ΣXd2(k) is larger than or equal to n times ΣXd1(k) (n is an integer number (e.g., 2)) and increased if not.

Another alternative approach is as follows. The first frequency band difference calculator 600 calculates first noise suppression amounts in the form of inter-microphone level differences ILD(k) of the respective frequency bands, and the second frequency band difference calculator 700 calculates second noise suppression amounts in the form of inter-microphone level differences of respective sets of a frequency band concerned and adjacent frequency bands (e.g., ILD(k−1)+ILD(k)+ILD(k+1)). Noise suppression is performed if both of a first noise suppression amount and a second noise suppression amount are both larger than a threshold value (a small positive value such as 3 dB). This provides an effect that suppression is made erroneously in a voice band.

Step S62: Second frequency band power differences are calculated in the noise suppressor 16. The second frequency band difference calculator 700 calculates differences between powers in respective frequency bands of the signals supplied from the first audio input receiver 400 and the second audio input receiver 450. The power differences calculation method may be same as or different than employed at step S61.

Step S63: First noise suppression amounts are calculated in the noise suppressor 16. The first noise suppression amount calculator 650 calculates first noise suppression amounts G_1(k) for the respective frequency bands in the following manner based on outputs of the first frequency band difference calculator 600.

G_{—}1(k)=α×ILD1(k) (5)

where α is a constant (e.g., 0.5) and ILD1(k) is the output for the band k of the first frequency band difference calculator 600.

Step S64: Second noise suppression amounts are calculated in the noise suppressor 16. The second noise suppression amount calculator 750 calculates second noise suppression amounts G_2(k) for the respective frequency bands based on outputs of the second frequency band difference calculator 700 in the following manner.

G_{—}2(k)=β×ILD1(k) (6)

where β is a constant (e.g., 0.3) and ILD2(k) is the output for the band k of the second frequency band difference calculator 700.

Step S65: The final noise suppression amounts are determined in the noise suppressor 16. The noise suppression amount determinator 800 calculates final noise suppression amounts based on the first noise suppression amounts supplied from the first noise suppression amount calculator 650 and the second noise suppression amounts supplied from the second noise suppression amount calculator 750 according to a result of a judgment as to whether the current interval is a non-voice interval or not.

That is, the degree of suppression is varied depending on whether a necessary signal is obtained or not; the degree of suppression is lowered if the current interval is not a non-voice interval (i.e., it is a voice interval) and the degree of suppression is increased if the current interval is a non-voice interval.

Step S66: Noise suppression is the noise suppressor 16. The noise suppressor 900 (gain multiplier) suppresses noise components contained in the audio signal that is input from the second audio input receiver 450 according to the noise suppression amounts supplied from the noise suppression amount determinator 800. More specifically, the noise suppressor 900 calculates a noise-suppressed spectrum Y(n) by multiplying the amplitude spectrum X2(n) by a gain G_1(k)+G_2(k) on a band-by-band basis (i.e., weighting is done). The frequency inverter 950 converts the noise-suppressed spectrum Y(n) (and a corresponding phase spectrum P(n)) into a time domain audio signal y(t).

Step S67: An audio signal is output. The audio coder 17 performs audio compression processing on the time domain audio signal y(t) and sends a resulting signal to the system controller 130.

One important feature of the embodiment relates to the calculation method of noise suppression amounts. That is, a power difference corresponding to each frequency band is calculated through accumulation over plural frequency bands and a noise suppression amount is modified if the calculated power difference is small. Since a suppression amount is calculated based on power differences in plural frequency bands, attenuation of a voice and insufficient suppression of noise can be avoided. In a non-voice interval, large suppression mounts can be realized by adding second suppression amounts.

The invention is not limited to the above embodiment itself and may be practiced in such a manner that components are modified in various manners without departing from the spirit and scope of the invention. For example, although the embodiment is directed to the noise suppression device used in a cellphone, a smartphone, a PDA, or the like, the invention can also be applied to all apparatus, circuits, etc. that handle an audio signal such as (slate) tablet terminals, mobile communication terminals, fixed telephones, conference systems, speech recognition apparatus, and LSIs.

Various inventive concepts may be conceived by properly combining plural components disclosed in the embodiment. For example, several ones of the components of the embodiment may be omitted.

1. An audio processing device comprising:
a first audio input receiver configured to receive mainly environment noise;
a second audio input receiver configured to receive mainly a voice;
a first frequency band difference calculator configured to calculate a first power difference, obtained through accumulation over plural frequency bands, of signals output from the first audio input receiver and the second audio input receiver;
a first noise suppression amount calculator configured to calculate a first noise suppression amount based on the first power difference so as to increase the first noise suppression amount if the first power difference is relatively small; and
a noise suppressor configured to perform a noise suppression for the signal that is output from the second audio input receiver based on the first noise suppression amount.

2. The audio processing device of claim 1, further comprising:
a second frequency band difference calculator configured to calculate a second power difference, obtained through accumulation over plural frequency bands, of the signals output from the first audio input receiver and the second audio input receiver; and
a second noise suppression amount calculator configured to calculate a second noise suppression amount based on the second power difference,
wherein, in a non-voice interval, the noise suppressor performs the noise suppression for the signal that is output from the second audio input receiver based on the first noise suppression amount added with the second noise suppression amount.

3. The audio processing device of claim 2,
wherein the first noise suppression amount calculator increases the first noise suppression amount if both of the first power difference and the second power difference are larger than or equal to respective prescribed threshold values.

4. A noise suppression method comprising:
calculating a first power difference, obtained through accumulation over plural frequency bands, of signals output from a first audio input receiver and a second audio input receiver;
calculating a first noise suppression amount based on the first power difference so as to increase the first noise suppression amount if the first power difference is relatively small; and
performing a noise suppression for the signal that is output from the second audio input receiver based on the first noise suppression amount.

5. The noise suppression method of claim 4, further comprising:
calculating a second power difference, obtained through accumulation over plural frequency bands, of the signals output from the first audio input receiver and the second audio input receiver; and
calculating a second noise suppression amount based on the second power difference,
wherein, in a non-voice interval, the noise suppression is performed for the signal that is output from the second audio input receiver based on the first noise suppression amount added with the second noise suppression amount.
